(19) United States
(12) Patent Application Publication
(10) Pub. No.: US 2012/0157159 A1
(43) Pub. Date: Jun. 21, 2012

(54) COMMUNICATION APPARATUS USING IMAGE SENSOR AND ERROR CORRECTION METHOD

(75) Inventors: Il-Soon JANG, Daejeon (KR); Dae Ho Kim, Daejeon (KR); Sang-Kyu Lim, Daejeon (KR); You Jin Kim, Daejeon (KR); Tae-Gyu Kang, Daejeon (KR)

(73) Assignee: ELECTRONICS AND TELECOMMUNICATIONS RESEARCH INSTITUTE, Daejeon (KR)

(21) Appl. No.: 13/326,902

(22) Filed: Dec. 15, 2011

(30) Foreign Application Priority Data
Dec. 17, 2010 (KR) 10-2010-0130171
Apr. 18, 2011 (KR) 10-2011-0035828

(51) Int. Cl. H04N 5/262; H04W 88/02

(52) U.S. Cl. 455/556.1; 348/240.99; 348/E05.055

(57) ABSTRACT

A communication apparatus using an image sensor captures an image including a light signal transmitted from a transmission apparatus that includes a transmission light source, and obtains data from the captured image. In a case that a reception error rate generated by the obtained data is changed, a cause of the change of the error rate is measured, and at least one of a zooming operation and a focusing operation is performed depending on the measured result, thereby correcting the error.

### CROSS-REFERENCE TO RELATED APPLICATION

This application claims priority to and the benefit of Korean Patent Application Nos. 10-2010-0130171 and 10-2011-0035828 filed in the Korean Intellectual Property Office on Dec. 17, 2010 and Apr. 18, 2011, the entire contents of which are incorporated herein by reference.

### BACKGROUND OF THE INVENTION

(a) Field of the Invention

The present invention relates to a communication apparatus. More particularly, the present invention relates to a communication apparatus using an image sensor and an error correction method.

(b) Description of the Related Art

A system for communicating using an image sensor performs communication using visible light generated using an image sensor such as a light diode, which is not harmful to the human body, does not need frequency permission, and can provide a physical security function since it uses light. A variety of studies have recently been performed concerning visible light wireless communication.

A camera has a function of receiving external visible image information, and is capable of performing a visible light communication using such a function. In detail, a transmitting apparatus transmits visible light having a predetermined frequency by turning on/off a transmission light source depending on data to be transmitted, and a receiving apparatus performs image capture of the visible light transmitted using a camera and processes the signal corresponding to the captured image to obtain the transmitted data.

However, in case of communication using a camera, a case that the camera draws closer the transmitting apparatuses as a camera user moves occurs. For example, in a case that there are a plurality of transmitting apparatuses, the distance between a receiving apparatus including a camera and the transmitting apparatuses becomes smaller as a user moves, so that a reception error rate of the light transmitted from a plurality of transmitting light sources increases.

In detail, a receiving apparatus that communicates using an image sensor such as a camera captures even an image of the light source including the visible light transmitted from the transmission light source. In such a case, the distance between transmission light sources captured in the receiving apparatus becomes different as the receiving apparatus moves. In the case that the distance between the transmission light sources becomes smaller, a change in images captured by the receiving apparatus occurs so an error in data depending on the visible light received from each of the transmission light sources occurs. That is, interference occurs between transmission light sources so that an error rate of receiving data may increase.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a communication apparatus and error correction method using an image sensor having advantages of minimizing interference occurring between transmitting light sources as an image sensor moves in a case of communicating using the image sensor.

An object of the present invention is to provide a communication apparatus for minimizing interference occurring between transmitting light sources as an image sensor moves in a case of communicating using the image sensor, and an error correction method.

According to an exemplary embodiment of the present invention, an error correction method in a communication apparatus communicating with a transmitting apparatus which includes a transmission light source and using an image sensor is provided, the method including: capturing an image including a light signal transmitted from the transmitting light source to obtain data; measuring a reception error rate on the basis of the obtained data; and performing at least one of a zooming operation and a focusing operation for the image sensor in case it is determined that the reception error rate is increased. Here, the step of performing may include identifying the cause of the reception error rate increase in case it is determined that the reception error rate is increased, and performing at least one of the zooming operation and the focusing operation for the image sensor depending on the cause.

The step of performing may include identifying the cause of the reception error rate increase in case it is determined that the reception error rate is increased, and performing at least one of the zooming operation and the focusing operation for the image sensor depending on the cause.

According to another exemplary embodiment of the present invention, a communication apparatus using an image sensor for communicating with a transmitting apparatus that includes a transmission light source is provided, the communication apparatus including: an image sensor for capturing an image including a light signal that is transmitted from the transmission light source; a zoom controller for performing a zooming function for image capture of the image sensor; a focus controller for performing a focusing function for image capture of the image sensor; a data obtaining unit for obtaining data from the captured image; an error rate measuring unit for measuring a reception error rate on the basis of the obtained data; and an operating coupler for operating at least one of the zoom controller and the focus controller to perform at least one of a zooming operation and a focusing operation for the image sensor, in a case that it is determined that the reception error rate is increased.

The communication apparatus according to an exemplary embodiment of the present invention may further include an error cause measuring unit for measuring a cause of the change of the reception error rate, and the error cause measuring unit may include at least one of: a light source distance measuring module for searching for a transmission light source and a neighboring transmission light source from the captured image, and measuring the distance between the transmission light source and the searched neighboring transmission light source; a light source magnitude measuring module for measuring the magnitude of the transmission light source from the captured image; and a light source brightness measuring module for measuring brightness of the transmission light source from the captured image.

### BRIEF DESCRIPTION OF THE DRAWINGS

FIG. 1 is a configuration diagram illustrating a communication apparatus using an image sensor according to an exemplary embodiment of the present invention.

FIG. 2 is an exemplary diagram illustrating a transmission light source according to an exemplary embodiment of the present invention.

FIG. 3 is an exemplary diagram illustrating change of distance of a transmission light source as a user moves as illustrated in FIG. 2.

FIG. 4 is a graph illustrating a state in which a reception error rate increases.

FIG. 5 is a view illustrating a structure of an error cause measuring unit according to an exemplary embodiment of the present invention.

FIG. 6 is a flowchart illustrating an error correction method according to an exemplary embodiment of the present invention.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. Throughout the specification, unless explicitly described to the contrary, the word “comprise” and variations such as “comprises” or “comprising” will be understood to imply the inclusion of stated elements but not the exclusion of any other elements.

Hereinafter, a communication apparatus and communication method using an image sensor according to an exemplary embodiment of the present invention will be described with reference to the accompanying drawings.

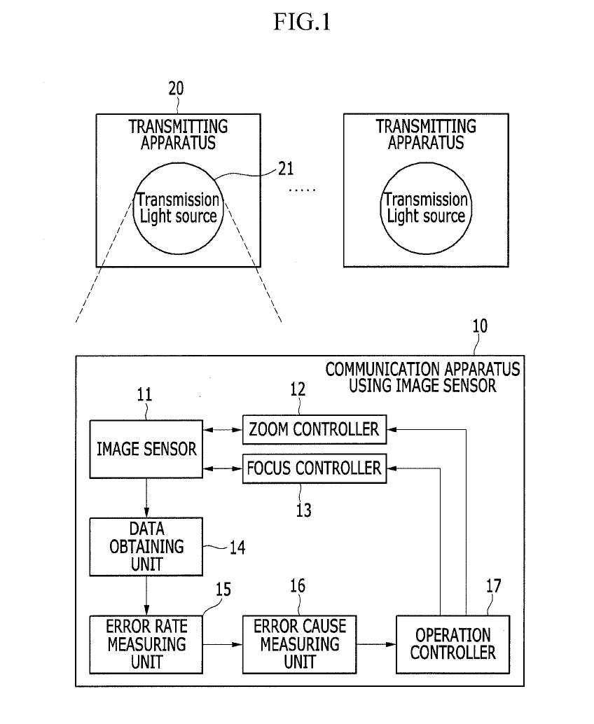

FIG. 1 is a configuration diagram illustrating a communication apparatus using an image sensor according to an exemplary embodiment of the present invention.

As illustrated in attached FIG. 1, a communication apparatus 10 using an image sensor according to an exemplary embodiment of the present invention includes an image sensor 11, a zoom controller 12, a focus controller 13, a data obtaining unit 14, an error rate measuring unit 15, an error cause measuring unit 16, and an operation controller 17.

The communication apparatus 10 using an image sensor receives and processes light transmitted from transmitting apparatuses 20 including a transmission light source 21. A light emitting device (LED) is generally used as a transmission light source, and includes a white LED, a red LED, a green LED, and a blue LED.

The image sensor 11 captures an image including the received light and outputs an electrical signal corresponding to the image. The image sensor 11 is a sensor to output the signal corresponding to the input light, which may be imaging elements used in a general camera.

The transmitting light source 21 of the transmitting apparatus 20 is turned on/off depending on the data to be transmitted, and the light signal is transmitted depending on the turning on/off of the transmission light source. While the image sensor 11 of the communication apparatus 10 using an image sensor receives the light signal transmitted from the transmission light source 21, it also captures the image of the transmission light source depending on the visible light input from the outside.

The zoom controller 12 performs a zooming function for image capture, which may be embodied in a form including a lens group having at least one lens that can move from a wide-angle position to a telephoto position and a motor that moves the lens group, for example.

The focus controller 13 performs a focusing function for image capture, which may be embodied in a form including a motor that moves a focusing lens included in a lens group to focus, for example.

According to an exemplary embodiment of the present invention, the image sensor 11, the zoom controller 12, and the focus controller 13 may also be collectively referred to an imaging apparatus, and such an imaging apparatus may be a camera.

Meanwhile, the data obtaining unit 14 obtains an image captured by processing the signal output from the image sensor 11 and the data transmitted from the captured image. Since a process technology to capture an image on the basis of a signal output from an image sensor is well known in the art, so a detailed description thereof is omitted here.

The error rate measuring unit 15 measures a receiving error rate and determines whether the measured receiving error rate increases to a predetermined error rate or more. The receiving error rate may increase depending on a change of the distance of the transmitting light source that occurs as a user having the communication apparatus 10 using an image sensor moves.

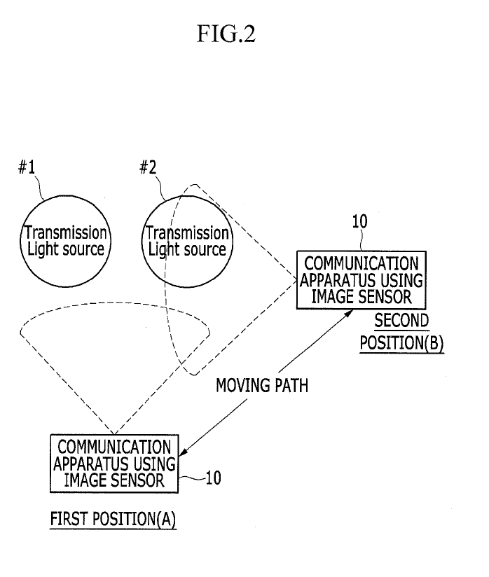

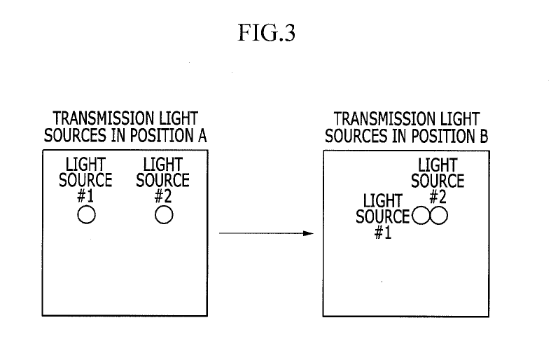

FIG. 2 is an exemplary diagram illustrating a transmission light source according to an exemplary embodiment of the present invention, and FIG. 3 is an exemplary diagram illustrating a change of distance of a transmission light source as a user moves as illustrated in FIG. 2.

For example, as illustrated in FIG. 2, in the state that transmission light sources #1 and #2 are positioned, the communication apparatus 10 using an image sensor may move from a first position A to a second position B. In such a case, when viewed from the communication apparatus 10 using an image sensor, a situation that transmission light sources #1 and #2 are close to each other occurs as illustrated in FIG. 3. That is, as illustrated in FIG. 3, although the distance between the transmission light sources #1 and #2 is not changed, it is identified that the transmission light sources #1 and #2 draw closer to each other from the images captured in the communication apparatus 10 using an image sensor as the communication apparatus 10 using an image sensor moves. That is, although it is identified that the transmission light sources #1 and #2 are separated from each other by a predetermined distance from the image shot in the first position A, it is identified that the transmission light sources #1 and #2 are positioned close to each other from the image shot in the second position B. In such a case, a receiving error rate of the data transmitted from each transmission light source increases.

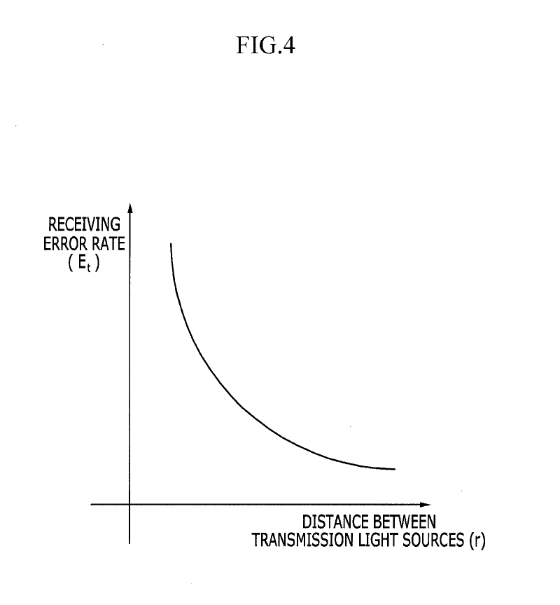

FIG. 4 is a graph illustrating a state that a reception error rate increases.

For example, as illustrated in FIG. 3, a receiving error rate of the data transmitted from the transmission light source #1 increases as the user moves and then the transmitting light source #1 and the other transmitting light source #2 draw closer each other. That is, as the distance between the transmission light sources #1 and #2 becomes smaller, it is known that the receiving error rate increases.

When a case that a receiving error rate is measured and the measured error rate changes or increases to a predetermined change rate or more occurs in an exemplary embodiment of the present invention, a zooming operation is performed or a focusing operation is performed so that an error rate occurring by the interference between the lights transmitted from the transmission light sources decreases.

To do this, the error rate measuring unit 15 measures an error rate for a light signal transmitted from an arbitrary transmission light source, and checks a receiving error occurrence cause through the error cause measuring unit 16 in a case that the measured receiving error rate changes in the increasing direction or increases to a predetermined error rate or more. Here, the transmitting side attaches a cyclic redundancy check (CRC) to data and transfers them, and the error rate measuring unit 15 can check the CRC and measure a receiving error rate of the data. However, it is not necessarily restricted to this.

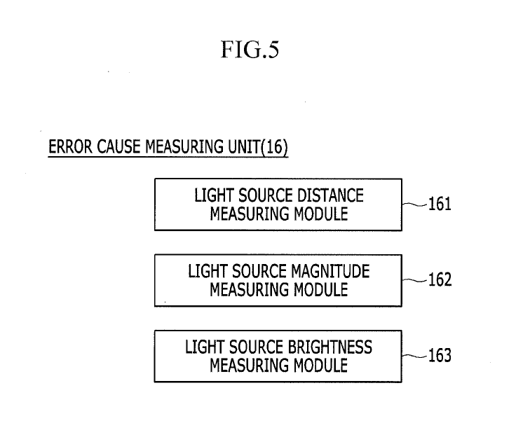

The error cause measuring unit 16 measures a cause of change of the receiving error rate, and therefore includes a light source distance measuring module 161, a light source magnitude measuring module 162, and a light source brightness measuring module 163 as illustrated in FIG. 5.

FIG. 5 is a view illustrating a structure of an error cause measuring unit 16.

The light source distance measuring module 161 searches for another transmission light source neighboring the transmission light source from the captured image, and measures the distance between the transmission light source and the neighboring transmission light source. As illustrated in FIG. 3, in the case that the error rate of the light signal received as the user moves to the second position B while the light signal is transmitted from the transmission light source #1 is increased, the neighboring transmission light source #2 is searched for, and the distance between the neighboring transmission light source #2 that has been searched for and the transmission light source #1 is measured.

For example, in the case that an image including a light signal output from the transmission light source is captured, it may be possible for the brightness of a position corresponding to the transmission light source to be the highest on the captured image. Accordingly, a position that is brighter than the brightness predetermined in the captured image in advance is found and is then considered to be the position of the transmission light source that communicates at the brightest position, and it can be regarded that another position that is brighter than the predetermined brightness is a position of a neighboring transmission light source. On the basis of positions of the transmission light source and neighboring transmission light source regarded as such, it is possible to measure the distance between the transmission light source and the neighboring transmission light source. However, this method is only one example, and it is also possible to measure the distance between the transmission light source and the neighboring transmission light source with another method.

Meanwhile, the light source magnitude measuring module 162 measures the magnitude of the transmission light source. Since the captured image includes the transmission light source that has also been captured, the transmission light source may be measured from the captured image. Accordingly, it is possible to measure whether the magnitude of the transmission light source has changed using the captured images.

The light source brightness measuring module 163 measures the brightness of the transmission light source. For example, it is possible to extract a transmission light source part from the captured image and measure the brightness of the transmission light source on the basis of a value of the brightness of the extracted part.

For example, values of the brightness of the extracted part are summed to be used as the brightness of the transmission light source. By this, it is possible to measure whether the brightness of the transmission light source has changed using the captured images.

According to an exemplary embodiment of the present invention, the error cause measuring unit 16 measures the distance between the transmission light source and the neighboring transmission light source through the light source distance measuring module 161, measures the magnitude of the transmission light source through the light source magnitude measuring module 162, or measures the brightness of the transmission light source through the light source brightness measuring module 163.

The operation controller 17 determines the cause of the receiving error rate increase on the basis of the data measured in the error cause measuring unit 16 if it is determined that the receiving error rate is in an increasing state. That is, it is determined whether the receiving error rate is increased because the distance between the transmission light source and the neighboring transmission light source is reduced, the communication apparatus using an image sensor has moved away from the transmission light source, or the focus was mismatched, and the zoom controller 12 or the focus controller 13 is operated depending on the determined result.

Next, an error correction method according to an exemplary embodiment of the present invention will be described on the basis of the communication apparatus 10 using an image sensor as described above.

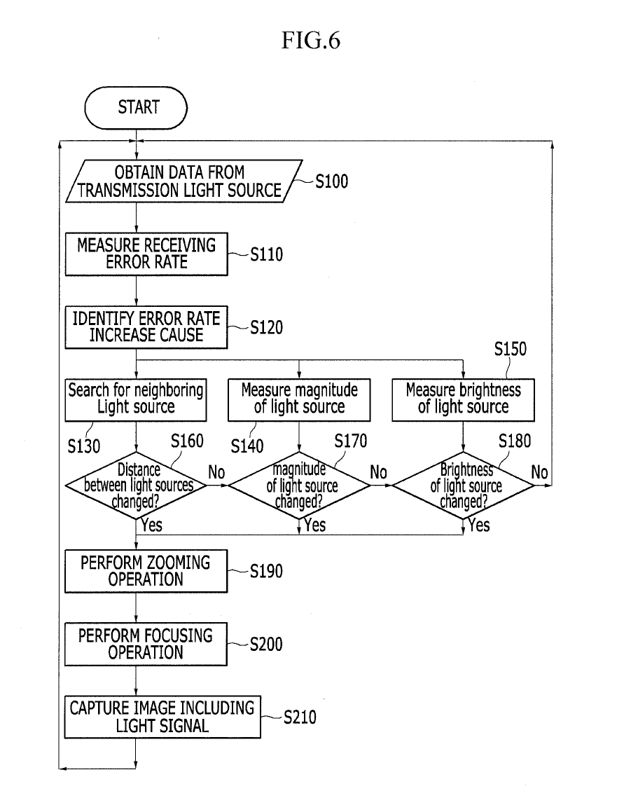

FIG. 6 is a flowchart illustrating an error correction method according to an exemplary embodiment of the present invention.

The communication apparatus 10 using an image sensor captures an image including a light signal transmitted from the transmission light source 21 of the transmitting apparatus 20, and performs image processing for the captured image so that the transmitting apparatus 20 obtains the transmitted data (S100).

An error rate of the data that is received in the state that the data is obtained (S110), and a cause of the received error rate increase is measured in the case that it is determined that the measured receiving error rate increases or it increases to exceed a predetermined value (S210). In order to determine the error cause, the error cause measuring unit 16 searches for a neighboring light source to measure the distance between the neighboring light source and the transmission light source (S130). Further, the magnitude of the transmission light source is measured (S140). Further, the brightness of the light source is measured (S150).

In detail, the error cause measuring unit 16 searches for a neighboring transmission light source. When the neighboring transmission light source is searched for, the distance between the transmission light source and the neighboring transmission light source is measured to determine whether the distance has changed (S160). That is, the operation controller 17 determines whether the distance becomes smaller by comparing it with the distance measured previously or if the measured distance is within the predetermined distance. As a result of the determination, in the case that the distance between the neighboring transmission light source and the transmission light source becomes smaller or becomes within the predetermined distance, it is determined that the receiving error increases by a change of the distance between the transmission light sources.

Meanwhile, in the case that the distance between the neighboring transmission light source and the transmission light source does not become smaller or does not become within the predetermined distance, the operation controller 17 determines whether the magnitude of the transmission light source has changed (S170). When it is determined that the magnitude of the transmission light source has changed to be smaller as a result of the determination, the distance between the transmission light source and the communication apparatus 10 using an image sensor is determined to be large so it is determined that the receiving error is increased.

Meanwhile, in the case that the magnitude of the transmission light source does not become smaller, the operation controller 17 determines whether the brightness of the transmission light source is changed (S180). As a result of the determination, in case that the brightness of the transmission light source is changed to become smaller than before or to fall below the predetermined brightness, it is determined that the receiving error is increased due to a problem of lens focus control.

As described above, when it is determined that the receiving error rate is increased due to a change of the distance between the transmission light sources, a change of the magnitude of the transmission light source, or a change of the brightness of the transmission light source, the operation controller 17 operates the zoom controller 12 so that the zooming operation is performed (S190). For example, it is possible to move a lens group through the zoom controller 12 of the communication apparatus using an image sensor in order to receive the light signal from the transmission light source more precisely.

The operation controller 17 also operates the focus controller 13 so that focus control for the transmitting light source 21 is performed (S200).

As such, in the case that it is determined that the receiving error rate is increased, a correction procedure wherein the zooming operation and focusing operation are implemented is performed, and a procedure wherein a procedure where an image including a light signal from the transmitting light source through the image sensor 11 is captured is performed (S210), so communication with the transmitting apparatus 20 is performed.

Meanwhile, in the exemplary embodiment described above, while the zooming operation and the focusing operation are performed in the case that it is determined that the receiving error rate is increased and the cause of the increase is the change of the distance between the transmission light sources, the change of the magnitude of the transmission light source, or the change of the brightness of the transmission light source, it may be possible to perform different corrections depending on the error cause.

For example, in the case that the receiving error rate is increased due to the change of the distance between the transmitting light sources, the zooming operation and the focusing operation are performed to correct the error. Meanwhile, in case it is determined that the receiving error rate is increased due to the change of the magnitude of the transmission light source, the zooming operation is performed to correct the error. Further, in case it is determined that the receiving error rate is increased due to the change of the brightness of the transmission light source, the focusing operation is performed to correct the error.

In case the receiving error rate is increased as described above, the error is corrected by at least one of the zooming operation and the focusing operation.

Meanwhile, in the case that there is no change of the distance between the transmission light sources in the exemplary embodiment, the light source magnitude is measured and the magnitude change is determined. Further, in the case that there is no change of the magnitude of the transmission light source, the above error correction method may be embodied in the order that the light source change measurement and the magnitude change determination are performed.

According to an exemplary embodiment of the present invention, when performing image sensor communication using a mobile phone camera and the like, it is possible to minimize interference between transmitting light sources by correcting the change of distance between the transmitting light sources as a user position moves using measurement of the distance between the transmitting light sources, magnitude of the light source, and brightness of the light source, thereby minimizing interference between the transmitting light sources.

Particularly, it is possible to detect a light signal from the transmitting light source more precisely by making an automatic zooming operation and an automatic focusing operation performed in a case that a receiving error occurs.

The exemplary embodiment of the present invention is not embodied only through the apparatus and/or method described above, but may be embodied through a program that embodies functions corresponding to constructions of the exemplary embodiment of the present invention or a recording medium, wherein such embodiment will be implemented by those skilled in the art from the description of the exemplary embodiment.

Hereinbefore, while an exemplary embodiment of the present invention has been described in detail, the scope of right of the present invention is not restricted thereto and various modifications and improvements of those skilled in the art that may be made using basic concepts of the present invention defined in the following claims are also included in the scope of right of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An error correction method in a communication apparatus communicating with a transmitting apparatus which includes a transmission light source and using an image sensor, the method comprising:
capturing an image including a light signal transmitted from the transmitting light source to obtain data;
measuring a reception error rate on the basis of the obtained data; and
performing at least one of a zooming operation and a focusing operation for the image sensor in a case it is determined that the reception error rate is increased.

2. The method of claim 1, wherein the step of performing includes
identifying the cause of the reception error rate increase in a case that it is determined that the reception error rate is increased, and
performing at least one of the zooming operation and the focusing operation for the image sensor depending on the cause.

3. The method of claim 2, wherein the step of identifying comprises:
identifying, on the basis of the distance between the transmission light source and a neighboring transmission light source, the change of the distance between the transmission light sources;
identifying the change of the magnitude of the transmission light source; and
identifying the change of the brightness of the transmission light source.

4. The method of claim 3, wherein the step of performing at least one of the zooming operation and the focusing operation includes performing at least one of a case that the distance between the transmission light sources becomes smaller, a case that the magnitude of the transmission light source becomes smaller, and a case that the brightness of the transmission light source becomes smaller.

5. The method of claim 4, wherein the step of performing at least one of the zooming operation and the focusing operation includes:
performing both of the zooming operation and the focusing operation in a case that the distance between the transmission light sources becomes smaller;
performing the zooming operation in a case that the magnitude of the transmission light source becomes smaller; and
performing the focusing operation in case that the brightness of the transmission light source becomes smaller.

6. A communication apparatus using an image sensor for communicating with a transmitting apparatus that includes a transmission light source, the communication apparatus comprising:
an image sensor for capturing an image including a light signal that is transmitted from the transmission light source;
a zoom controller for performing a zooming function for image capture of the image sensor;
a focus controller for performing a focusing function for image capture of the image sensor;
a data obtaining unit for obtaining data from the captured image;
an error rate measuring unit for measuring a reception error rate on the basis of the obtained data; and
an operating coupler for operating at least one of the zoom controller and the focus controller to perform at least one of a zooming operation and a focusing operation for the image sensor, in a case that it is determined that the reception error rate is increased.

7. The communication apparatus of claim 6, further comprising:
an error cause measuring unit for measuring a cause of the change of the reception error rate.

8. The communication apparatus of claim 7, wherein the error cause measuring unit includes at least one of:
a light source distance measuring module for searching for a transmission light source and a neighboring transmission light source from the captured image, and measuring the distance between the transmission light source and the searched neighboring transmission light source;
a light source magnitude measuring module for measuring the magnitude of the transmission light source from the captured image; and
a light source brightness measuring module for measuring brightness of the transmission light source from the captured image.

9. The communication apparatus of claim 8, wherein the operating controller operates at least one of the zoom controller and the focus controller in at least one of a case that the distance between the transmission light sources becomes smaller, a case that the magnitude of the transmission light source becomes smaller, and a case that the brightness of the transmission light source becomes smaller.

10. The apparatus of claim 9, wherein the zoom controller and focus controller operate in a case that the distance between the transmission light sources becomes smaller;
the zoom controller operates in a case that the magnitude of the transmission light source becomes smaller; and
the focus controller operates in a case that the brightness of the transmission light source becomes smaller.

11. The apparatus of claim 7, wherein the communication apparatus using an image sensor is embodied in a mobile phone.
